(19) United States
(12) Patent Application Publication
(10) Pub. No.: US 2021/0172780 A1
(43) Pub. Date: Jun. 10, 2021

(54) FLOWMETER

(71) Applicant: DENSO CORPORATION, Kariya-city (JP)

(72) Inventors: Kazuaki UEDA, Nisshin-city (JP); Kengo ITO, Kariya-city (JP)

(21) Appl. No.: 17/181,261

(22) Filed: Feb. 22, 2021

Related U.S. Application Data
(63) Continuation of application No. PCT/JP2019/022339, filed on Jun. 5, 2019.

(30) Foreign Application Priority Data
Aug. 24, 2018 (JP) 2018-157230

(51) Int. Cl. G01F 1/684; G01F 1/688

(52) U.S. Cl. CPC G01F 1/6842; G01F 1/688

(57) ABSTRACT

A flowmeter is disposed in a passage through which a fluid flows. The flowmeter includes a first passage and a second passage. The first passage defines a first opening through which at least a part of the fluid flows into the first passage from the passage. The second passage branches off from the first passage and includes a flow rate detector configured to detect a flow rate of the fluid flowing through the second passage from the first passage. The first passage includes a vortex reducer configured to restrict a vortex from generating.

### CROSS REFERENCE TO RELATED APPLICATION

The present application is a continuation application of International Patent Application No. PCT/JP2019/022339 filed on Jun. 5, 2019, which designated the U.S. and claims the benefit of priority from Japanese Patent Application No. 2018-157230 filed on Aug. 24, 2018. The entire disclosures of all of the above applications are incorporated herein by reference.

### TECHNICAL FIELD

The present disclosure relates to a flowmeter.

### BACKGROUND ART

A flowmeter is disposed in a passage through which a fluid flows and configured to measure a flow rate of the fluid flowing through the passage. The flowmeter includes a first passage defining an opening through which at least a part of the fluid flows into the flowmeter from the passage and a second passage that branches off from the first passage and includes a flow rate detector configured to detect a flow rate of the fluid flowing through the second passage from the first passage.

### SUMMARY

A flowmeter is disposed in a passage through which a fluid flows. The flowmeter includes a first passage that defines a first opening through which at least a part of the fluid flows into the flowmeter from the passage and a second passage that branches off from the first passage and includes a flow rate detector configured to detect a flow rate of the fluid flowing through the second passage from the first passage. The first passage includes therein a vortex reducer configured to restrict a vortex from generating.

### BRIEF DESCRIPTION OF DRAWINGS

FIG. 1 is a cross-sectional view of a flowmeter of a first embodiment.

FIG. 2 is a schematic view of the flowmeter viewed in a −Y direction.

FIG. 3 is a cross-sectional view of the flowmeter of the first embodiment.

FIG. 4 is a cross-sectional view of a flowmeter of a comparative example.

FIG. 5 is a cross-sectional view of a flowmeter of a second embodiment.

FIG. 6 is a cross-sectional view of the flowmeter of the second embodiment.

FIG. 7 is a cross-sectional view of a flowmeter of a third embodiment.

FIG. 8 is a cross-sectional view of a flowmeter of another embodiment.

FIG. 9 is a cross-sectional view of a flowmeter of another embodiment.

FIG. 10 is a schematic view of a flowmeter of another embodiment.

FIG. 11 is a schematic view of a flowmeter of another embodiment.

FIG. 12 is a cross-sectional view of a flowmeter of another embodiment.

FIG. 13 is a schematic view of a flowmeter of another embodiment.

FIG. 14 is a cross-sectional view of a flowmeter of another embodiment.

FIG. 15 is a cross-sectional view of a flowmeter of another embodiment.

FIG. 16 is a cross-sectional view of a flowmeter of another embodiment.

FIG. 17 is a cross-sectional view of a flowmeter of another embodiment.

FIG. 18 is a cross-sectional view of a flowmeter of another embodiment.

FIG. 19 is a cross-sectional view of a flowmeter of another embodiment.

### DESCRIPTION OF EMBODIMENTS

To begin with, examples of relevant techniques will be described.

A flowmeter is disposed in a passage through which a fluid flows and configured to measure a flow rate of the fluid flowing through the passage. The flowmeter includes a first passage defining an opening through which at least a part of the fluid flowing into the flowmeter from the passage and a second passage that branches off from the first passage and includes a flow rate detector configured to detect a flow rate of the fluid flowing through the second passage from the first passage.

When a flow rate of the fluid flowing into the first passage is uneven around an opening edge of the opening in such flowmeter, a vortex may be formed in the first passage. The generation of the vortex restricts the fluid from flowing into the second passage, which deteriorates an accuracy of the flow rate detector. Thus, a technique to restrict generation of vortices in the first passage of the flowmeter is needed.

According to an aspect of the present disclosure, a flowmeter is provided. The flowmeter is disposed in a passage through which a fluid flows. The flowmeter includes a first passage that defines a first opening through which at least a part of the fluid flows into the flowmeter from the passage and a second passage that branches off from the first passage and includes a flow rate detector configured to detect a flow rate of the fluid flowing through the second passage from the first passage. The first passage includes therein a vortex reducer configured to restrict a vortex from generating. According to such flowmeter, a vortex is restricted from generating in the first passage. Therefore, an accuracy of the flow rate detector is restricted from deteriorating, which is caused by restricting the fluid from flowing into the second passage.

### A. First Embodiment

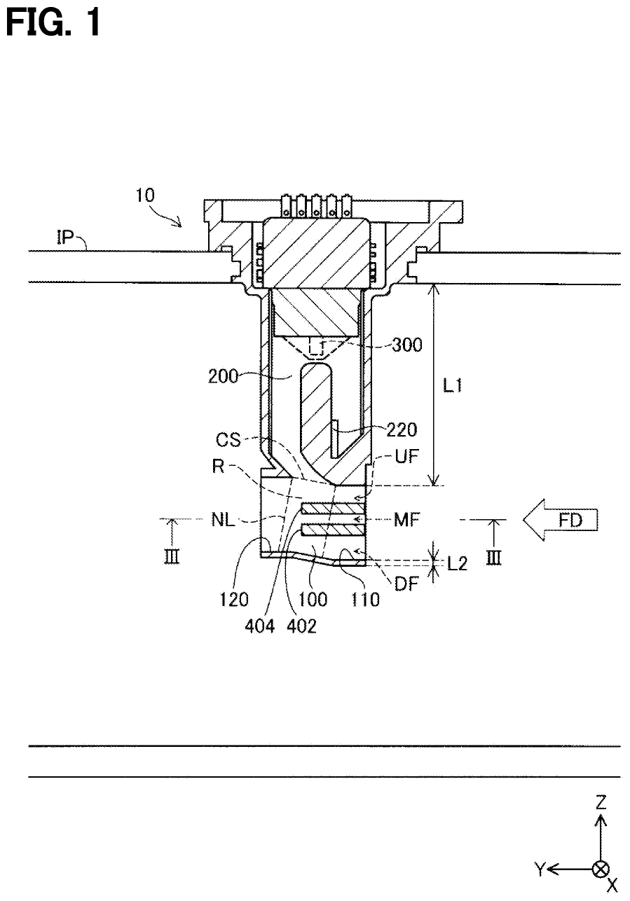

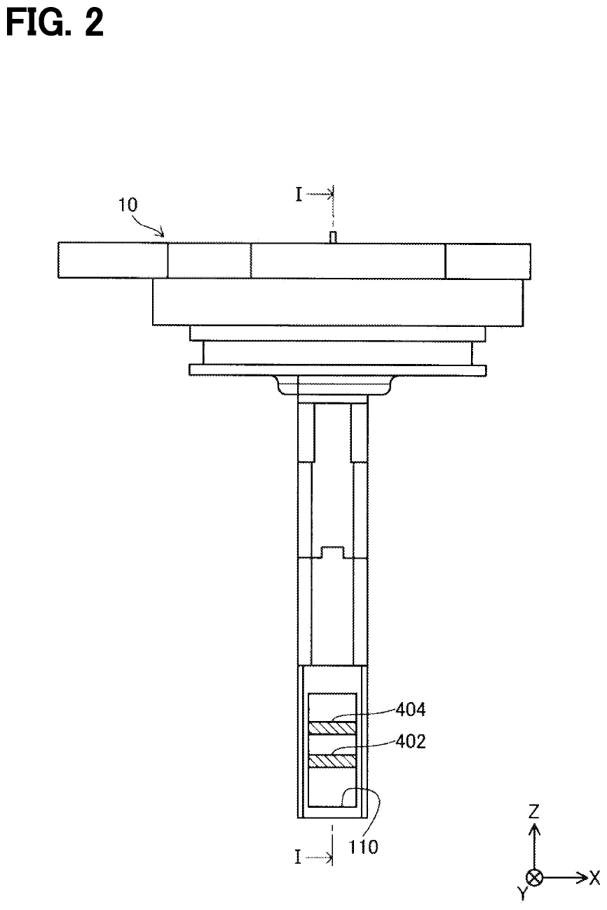

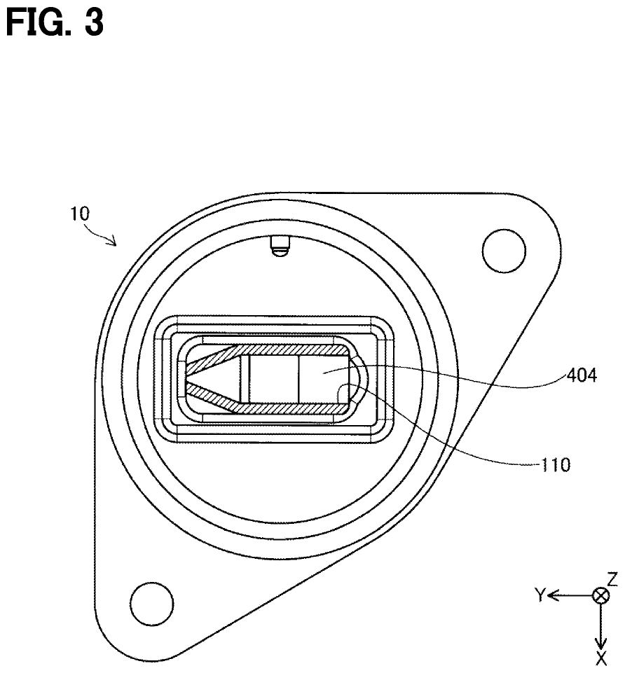

A flowmeter 10 shown in FIG. 1 is disposed in a passage through which a fluid flows and configured to detect a flow rate of the fluid flowing through the passage. In this embodiment, the flowmeter 10 is inserted into an intake pipe IP that guides the fluid to flow toward a cylinder of an internal combustion engine. XYZ axes in FIG. 1 are spatial axes perpendicular to each other. The XYZ axes in FIG. 1 correspond to XYZ axes in other drawings. FIG. 1 is a cross-sectional view of the flowmeter 10 taken along a YZ plane. Regarding a flow direction of the fluid in FIG. 1, a forward direction is a +Y direction and a backward direction is a −Y direction. The forward direction of the flow of the fluid is shown by a direction FD in FIG. 1. The cylinder of the internal combustion engine is disposed on a +Y side of the flowmeter 10 in FIG. 1. FIG. 2 is a side view of the flowmeter 10 viewed from a −Y side of the flowmeter 10. FIG. 1 is a cross-sectional view viewed in a direction of arrows I in FIG. 2. FIG. 3 is a cross-sectional view of the flowmeter 10 taken along a XY plane. FIG. 3 is a cross-sectional view viewed in a direction of arrows III in FIG. 1. The flowmeter 10 includes a first passage 100, a second passage 200, a flow rate detector 300, a plate member 402, and a plate member 404.

The first passage 100 is a passage into which a part of the fluid flowing through the intake pipe IP flows. The first passage 100 defines a first opening 100 on a −Y side of the first passage 100 and a second opening 120 on a +Y side of the first passage 100. The first passage 100 extends from the first opening 110 to the second opening 120. The flowmeter 10 has a part inserted into the intake pipe IP and a length L1 between the first opening 110 and a +Z side end of the part is longer than a length L2 between the first opening 110 and a −Z side end of the part.

The second passage 200 branches off from the first passage 100 and extends to the third openings 220. One of the third openings 220 opens in a wall surface located on the +X side of the flowmeter 10. The other one of the third openings 220 opens in a wall surface located on the −X side of the flowmeter 10 (not shown in FIG. 1).

The flow rate detector 300 is located on a +Z side of the second passage 200. The flow rate detector 300 is configured to detect a flow rate of the fluid flowing through the second passage 200 from the first passage 100. In the cross-sectional view in FIG. 1, the flow rate detector 300 is located on a far side (i.e., +X side) of a plane of paper, thus the flow rate detector 300 is shown by dashed lines. In this embodiment, the flow rate detector 300 is a hot-wire type flow rate detector. The flow rate detector 300 may be a flap type or a Karman vortex type flow rate detector.

The plate member 402 and the plate member 404 are located inside the first passage 100. Both of the plate member 402 and the plate member 404 extend in the Y direction. The plate member 402 is located on a −Z side of the plate member 404. In this embodiment, a part of the plate member 402 and a part of the plate member 404 exists within an area R surrounded by a dashed line. The second passage 200 has an opening CS at which the second passage 200 branches off from the first passage 100. The area R is defined by the opening CS, a normal line plane NL vertically extending from an edge of the opening CS, and an inner surface of the first passage 100. In other words, the area R is defined by projecting the opening CS along a normal vector of the opening CS. Each of the plate member 402 and the plate member 404 has a −Y side end located at a −Y side end of the first passage 100.

As shown in FIG. 2, each of a length of the plate member 402 and the plate member 404 in the X direction is set such that the plate members 402 and 404 cross the first passage 100 in the X direction. Both of the plate member 402 and the plate member 404 are connected to a part of the inner surface located on a +X side of the first passage 100 and a part of the inner surface located on the −X side of the first passage 100.

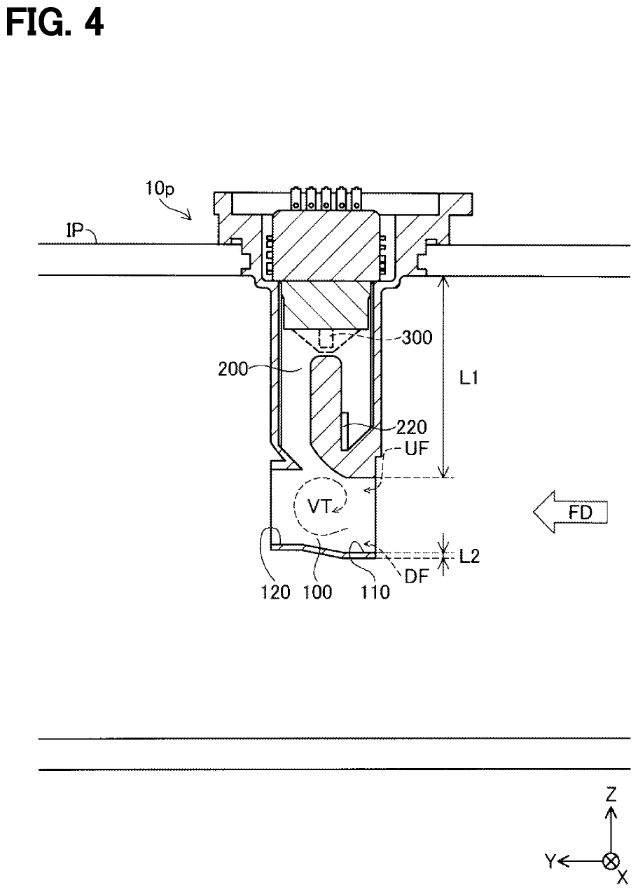

In the flowmeter 10, the plate member 402 and the plate member 404 are located inside the first passage 100, so that a vortex is less likely to be generated in the first passage 100. A generation of vortices will be described with reference to FIG. 4.

A flowmeter 10p of a comparative example shown in FIG. 4 is different from the flowmeter 10 of this embodiment in that the flowmeter 10p does not include the plate member 402 and the plate member 404. The same reference numerals as in the first embodiment donate the same structural components, and reference is made to the preceding description.

In the flowmeter 10p of the comparative example, when a part of the fluid flowing through the intake pipe IP in the +Y direction (i.e., the forward direction) flows into the first passage 100, a flow UF and a flow DF are generated around an edge of the first opening 110. The flow UF is a flow of the fluid reflected at a part of the flowmeter 10p on a +Z side of the first opening 110 and flowing into the first passage 100. The flow DF is a flow of the fluid reflected at a part of the flowmeter 10p on a −Z side of the first opening 110 and flowing into the first passage 100.

Similarly to the flowmeter 10 of the first embodiment, the length L1 is longer than the length L2 in the flowmeter 10p of the comparative example. Thus, an amount of the fluid reflecting at a part of the flowmeter 10p on a +Z side of the first opening 110 and changing its direction is larger than an amount of the fluid reflected at a part of the flowmeter 10p on a +Z side of the first opening 110 and changing its direction. As a result, the flow DF is more likely to be faster than the flow UF. Thus, a flow rate of the fluid flowing into the first passage 100 is biased at the edge of the first opening 110, so that a vortex VT is sometimes generated in the first passage 100. The vortex VT restricts the fluid from flowing into the second passage 200 and deteriorates a detecting accuracy of the flow rate detector 300.

In contrast, also in the flowmeter 10 of the first embodiment shown in FIG. 1, when a part of the fluid flowing through the intake pipe IP in the Y direction (i.e., the forward direction) flows into the first passage 100, a flow UF, a flow MF, and a flow DF are generated in the edge of the first opening 110. The flow MF is a flow of the fluid flowing to a center of the first opening 110 in the Y direction into the first passage 100. The flow UF and the flow DF are the same as the flow UF and the flow DF in FIG. 4. The flowmeter 10 of the first embodiment includes the plate member 402 and the plate member 404 inside the first passage 100 as a vortex reducer that reduces vortices. Thus, the vortex VT explained in the flowmeter 10p of the comparative example is less likely to be generated. Thus, a deterioration of the accuracy of the flow rate detector 300, which occurs when the fluid is restricted from flowing into the second passage 200, can be restricted.

Since the flowmeter 10 of the first embodiment includes the plate member 402 and the plate member 404 within the area R shown in FIG. 1, the vortex VT is restricted from generating in the area R.

### B. Second Embodiment

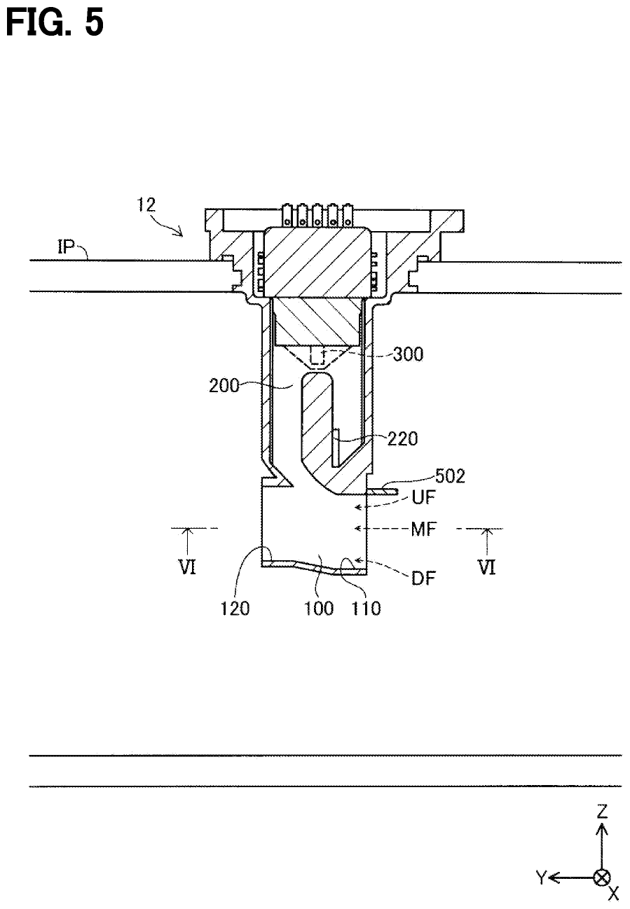

As shown in FIG. 5, a flowmeter 12 of a second embodiment differs from the flowmeter 10 of the first embodiment in that the flowmeter 12 does not include the plate member 402 and the plate member 404 and includes a protrusion 502. Other configurations are similar to those of the first embodiment. The same reference numerals as in the first embodiment denote the same structural components, and reference is made to the preceding description.

The flowmeter 12 includes the protrusion 502. The protrusion 502 protrudes outward from the edge of the first opening 110 in the −Y direction. In this embodiment, the protrusion 502 protrudes from a portion of the edge of the first opening 110 on a +Z side of the first opening 110.

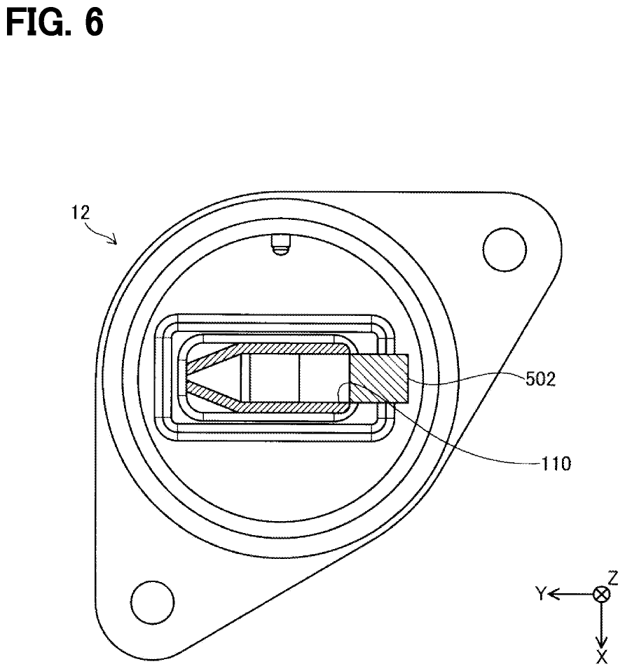

FIG. 6 is a cross-sectional view of the flowmeter 12 taken along a XY plane. The cross-sectional view of the flowmeter 12 in FIG. 6 is viewed along arrows VI in FIG. 5. The protrusion 502 has a rectangular shape when viewed from a −Z side of the protrusion 502.

Also in the flowmeter 12 of the second embodiment, when a part of the fluid flowing through the intake pipe IP in the Y direction (i.e., the forward direction) flows into the first passage 100, the flow UF and the flow DF are generated around the edge of the first opening 110. Since the flowmeter 12 of the second embodiment includes the protrusion 502, the fluid is reflected at the protrusion 502 (i.e., a portion located on the +Z side of the first opening 110) and changes its direction. As a result, an amount of the fluid flowing into the first opening is limited. Thus, a difference between a rate of the flow UF and a rate of the flow DF can be decreased compared to the flowmeter 10p of the comparative example in FIG. 4 and the flow rate of the fluid flowing into the first passage 100 is restricted from being biased at the edge of the first opening 110. Therefore, vortices VT are less likely to be generated in the first passage 100 and the deterioration of the accuracy of the flow rate detector 300, which occurs when the fluid is restricted from flowing into the second passage 200, can be restricted.

### C. Third Embodiment

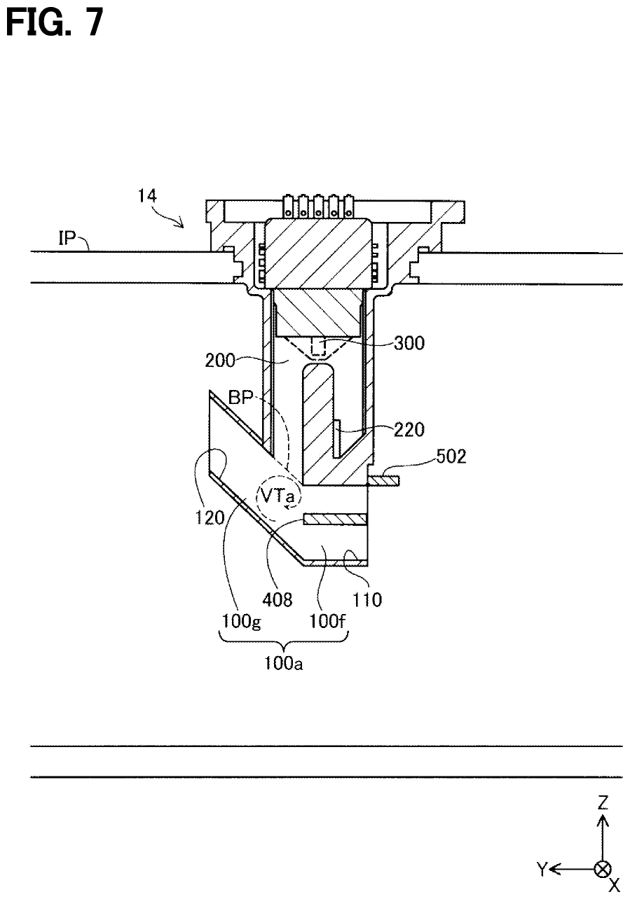

As shown in FIG. 7, a flowmeter 14 of a third embodiment differs from the flowmeter 12 of the second embodiment in that the flowmeter 14 includes a plate member 408 and a first passage 100a that has a different shape from the first passage 100. In addition, a shape of a portion of the second passage 200 near a branching position of the second passage 200 branching off from the first passage 100a is different from that of the second embodiment. Other configurations are similar to the flowmeter 12 of the second embodiment. The same reference numerals as in the first embodiment denote the same structural components, and reference is made to the preceding description.

The flowmeter 14 of the third embodiment includes the first passage 100a including a front passage 100f and a rear passage 100g. The front passage 100f is a passage between the first opening 110 and a branching position BP at which the second passage 200 branches off from the first passage 100a. The rear passage 100g is a passage between the second opening 120 and the front passage 100f. The rear passage 100g is tilted relative to the front passage 100f toward the second passage 200. In other words, the front passage 100f extends in the Y direction and the rear passage 100g is tilted relative to the Y direction to the +Z side of the front passage 100f. The plate member 408 is located in the front passage 100f.

According to the third embodiment described above, when a part of the fluid flowing through the intake pipe IP in the Y direction (i.e., the forward direction) flows into the first passage 100, the vortex is less likely to be generated as with the first embodiment and the second embodiment.

In the third embodiment, when the fluid flowing through the intake pipe IP in the −Y direction (i.e., a reverse direction of the forward direction) flows into the second passage 200 through the third opening 220, the following advantages can be obtained. That is, when the fluid flows in the −Y direction through the intake pipe IP, the fluid flowing into the rear passage 100g through the second opening 120 is likely to generate a vortex VTa around the branching position BP due to a difference of slopes between the front passage 100f and the rear passage 100g. The vortex VTa draws the fluid flowing from the third opening 220 to the flow rate detector 300 into the first passage 100a and restricts the fluid flowing through the rear passage 100g from the second opening 120 from flowing into the second passage 200. Thus, the fluid is not restricted from flowing into the flowmeter 14 through the third opening 220.

As described above, the flowmeter 14 does not restrict the fluid from flowing toward the flow rate detector 300 through the third opening 220 when the fluid flows backward in the intake pipe IP. Thus, the flowmeter 14 is effective when the flow rate detector 300 measures a flow rate of the fluid flowing in both forward and backward directions.

### D. Other Embodiments

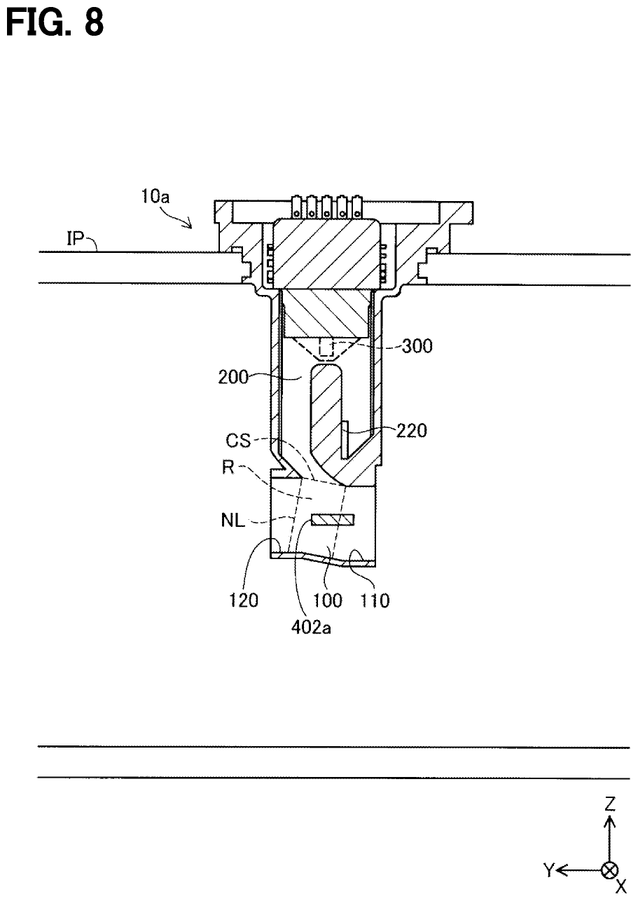

As shown in FIG. 8, a flowmeter 10a of a fourth embodiment differs from the flowmeter 10 of the first embodiment 10 in that the flowmeter 10a includes a plate member 402a in place of the plate member 402 and the plate member 404. Other configurations are similar to those of the first embodiment. Each of the plate member 402 and the plate member 404 of the first embodiment has the −Y side end that is located at the −Y side end of the first passage 100, but the present disclosure is not limited to this. As shown in FIG. 8, the −Y side end of the plate member 402a may be located between the −Y side end and +Y side end of the first passage 100. The flowmeter 10a of the fourth embodiment can obtain the same advantages with those of the first embodiment.

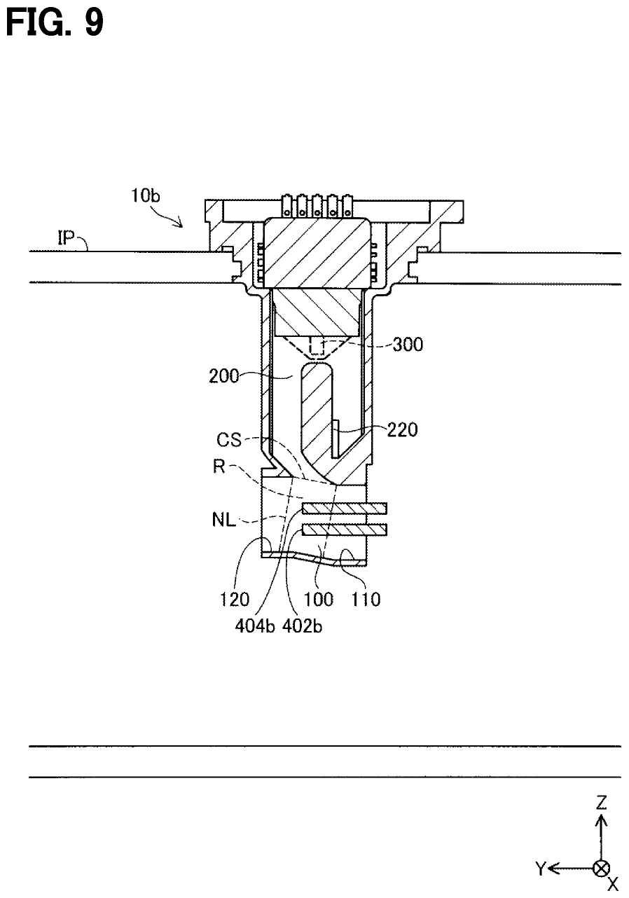

As shown in FIG. 9, a flowmeter 10b of a fifth embodiment differs from the flowmeter 10 of the first embodiment shown in FIG. 1 in that the flowmeter 10b includes a plate member 402b and a plate member 404b in place of the plate member 402 and the plate member 404. Other configurations are similar to those of the flowmeter 10 of the first embodiment. As shown in FIG. 9, each of −Y side ends of the plate member 402b and the plate member 404b may be located on a −Y side of the −Y side end of the first passage 100. That is, a part of each of the plate member 402b and the plate member 404b may be exposed to an outside of the first opening 110. The flowmeter 10b of the fifth embodiment can obtain similar advantages as those of the first embodiment.

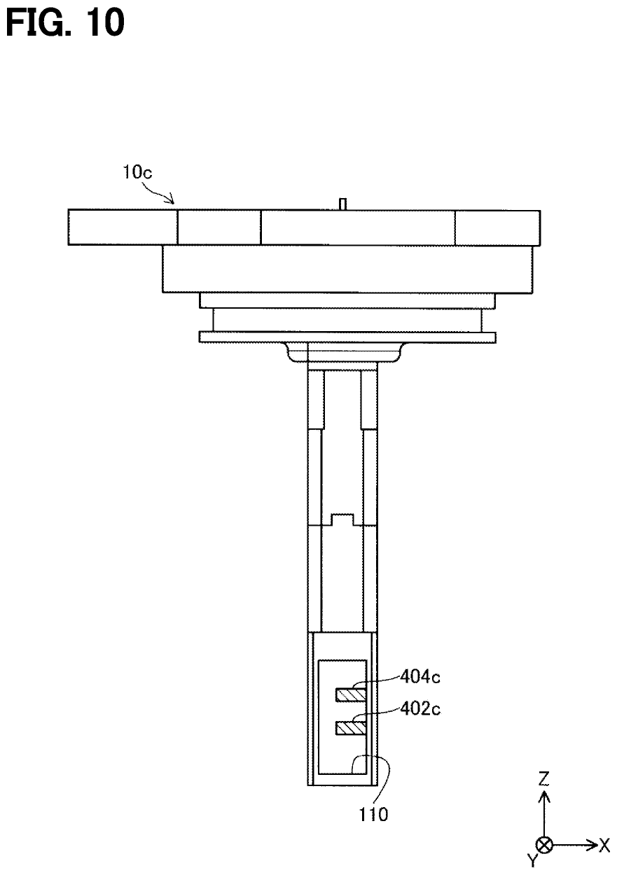

A flowmeter 10c of a sixth embodiment shown in FIG. 10 differs from the flowmeter 10 of the first embodiment shown in FIG. 2 in that the flowmeter 10c includes a plate member 402c and a plate member 404c in place of the plate member 402 and the plate member 404. Other configurations are similar to those of the flowmeter 10 of the first embodiment. Each of the plate member 402 and the plate member 404 of the first embodiment has a length in the X direction that crosses the first passage 100 in the X direction, but the present disclosure is not limited to this. For example, as shown in FIG. 10, a length in the X direction of each of the plate member 402c and the plate member 404c may be shorter than a length of the first passage 100 in the X direction. The plate member 402c and the plate member 404c are fixed to an inner wall surface of the first passage 100 that is located on a +X side of the first passage 100. The flowmeter 10c of the sixth embodiment can obtain similar advantages to those of the first embodiment.

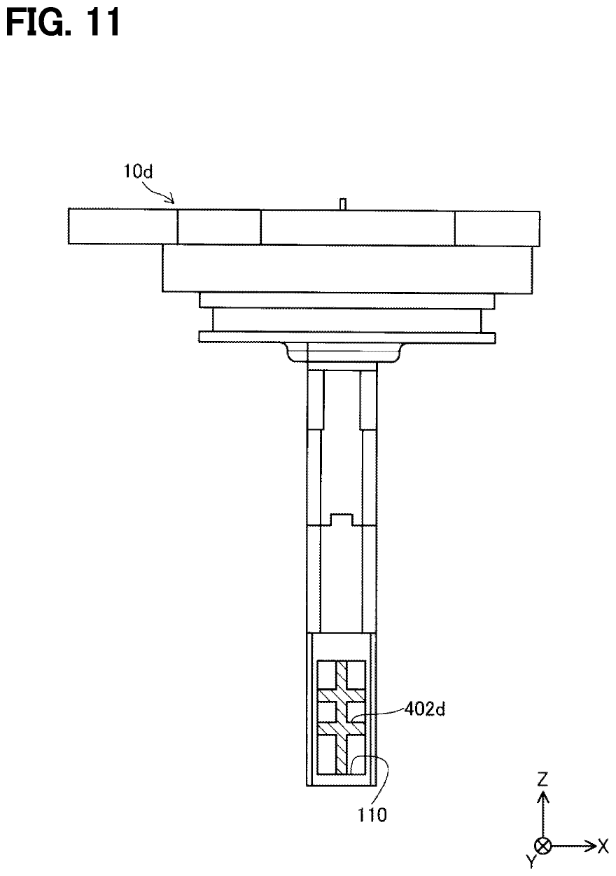

As shown in FIG. 11, a flowmeter 10d of a seventh embodiment differs from the flowmeter 10 of the first embodiment shown in FIG. 2 in that the flowmeter 10d includes a plate member 402d in place of the plate member 402 and the plate member 404. Other configurations are similar to those of the flowmeter 10 of the first embodiment. The plate member 402d has a lattice shape that divides the first passage 100. The flowmeter 10d of the seventh embodiment can obtain similar advantages to those of the first embodiment.

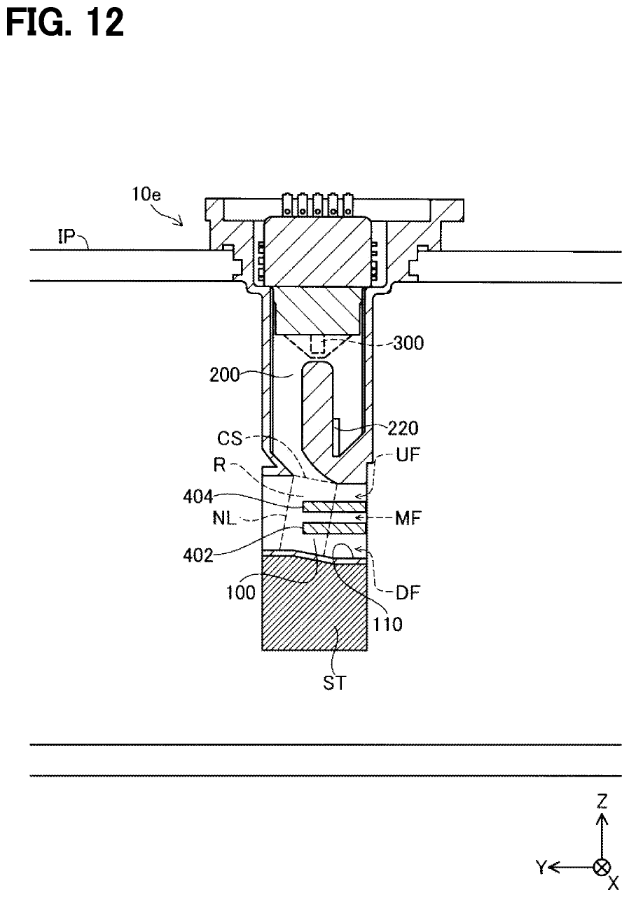

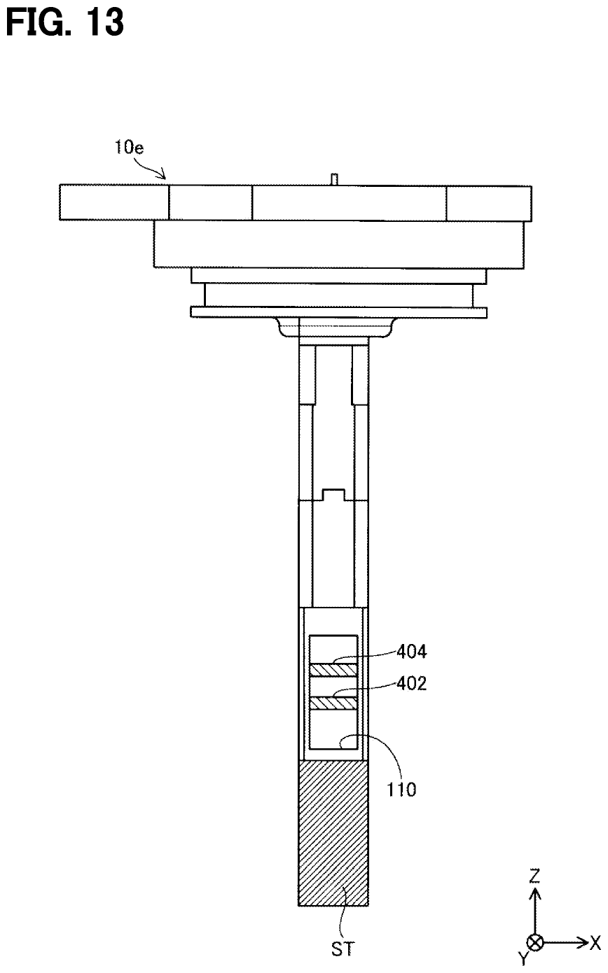

As shown in FIGS. 12 and 13, a flowmeter 10e of an eighth embodiment differs from the flowmeter 10 of the first embodiment shown in FIGS. 1 and 2 in that the flowmeter 10e includes a member ST. Other configurations are similar to those of the flowmeter 10 of the first embodiment. The flowmeter 10e includes the member ST on a −Z side of the first passage 100. An appearance of the member ST has a quadrangular prism shape. Because of the member ST, the flowmeter 10e can reduce a difference between an amount of the fluid reflected at a portion of the flowmeter 10e on a +Z side of the first opening 110 and changing its direction and an amount of the fluid reflected at a portion of the flowmeter 10e on a −Z side of the first opening 110 compared to the flowmeter 10 of the first embodiment. As a result, a difference between a velocity of the flow UF and a velocity of the flow DF can be decreased and a variation of the flow rate of the fluid flowing into the first passage 100 is restricted from generating at the edge of the first opening 110. As a result, the vortex VT is further restricted from generating in the first passage 100. A shape of the member ST is not limited to a shape in FIG. 12 while the member ST extends from the first opening 110 in the −Z direction.

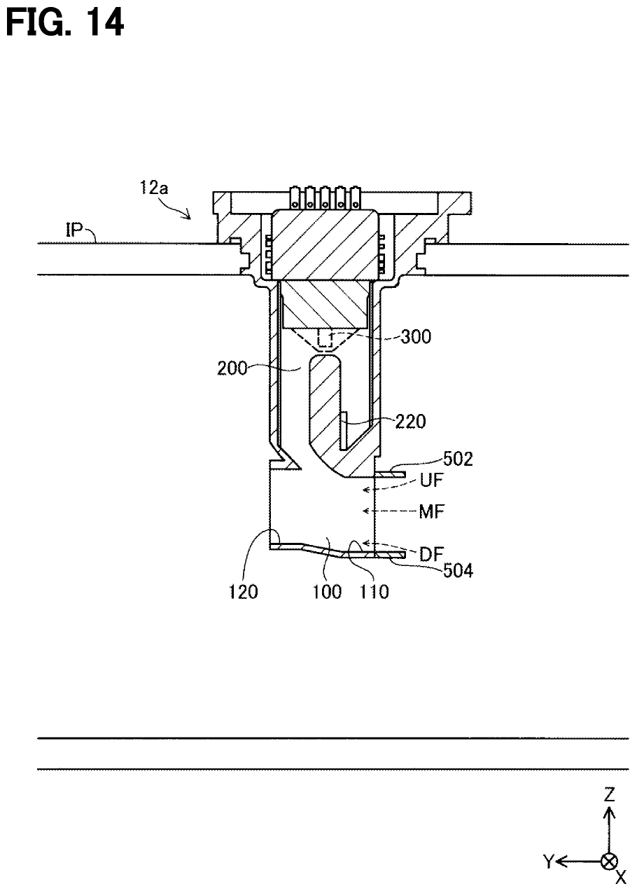

As shown in FIG. 14, a flowmeter 12a of a ninth embodiment differs from the flowmeter 12 of the second embodiment shown in FIG. 5 in that the flowmeter 12a includes a protrusion 504. Other configurations are similar to those of the second embodiment. The flowmeter 12a includes the protrusion 504 protruding from a portion of the edge of the first opening 110 located on the −Z side of the edge in addition to the protrusion 502 protruding from a portion of the edge of the first opening 110 located on the +Z side of the edge. A length of the protrusion 504 in the Y direction is the same as a length of the protrusion 502 in the Y direction. The flowmeter 12a can also reduce a difference between a velocity of the flow UF and a velocity of the flow DF as with the flowmeter 12 of the second embodiment. Thus, the fluid is restricted from biasedly flowing into the first passage 100 around the edge of the first opening 110. Therefore, the vortex VT is less likely to be generated in the first passage 100 and a deterioration of the flow rate detector 300, which is caused by the fluid restricted from flowing into the second passage 200, can be restricted.

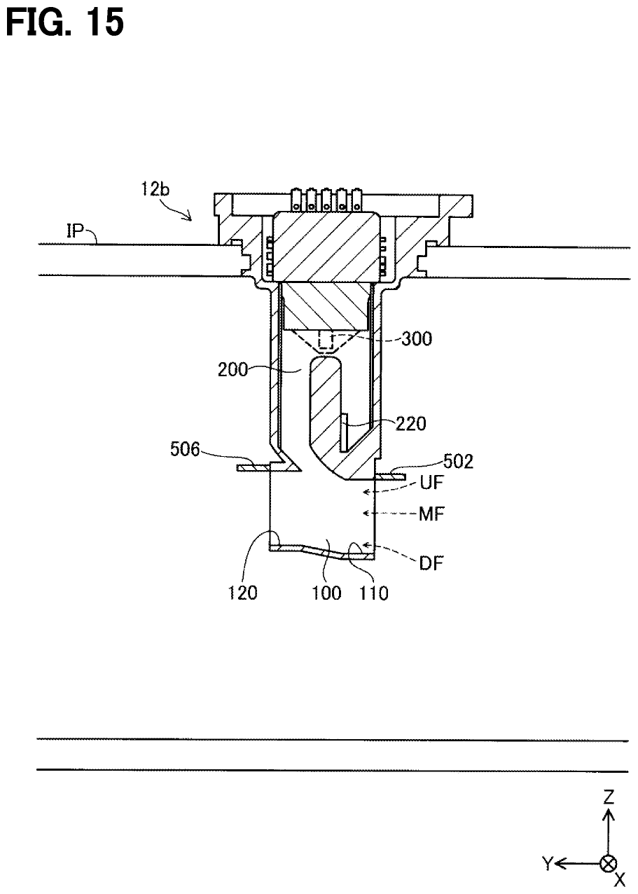

As shown in FIG. 15, a flowmeter 12b of a tenth embodiment differs from the flowmeter 12 of the second embodiment shown in FIG. 5 in that the flowmeter 12b includes a protrusion 506. Other configurations are similar to those of the flowmeter 12 of the second embodiment. The flowmeter 12a includes the protrusion 506 protruding from a portion of an edge of the second opening 120 on a +Z side of the edge in addition to the protrusion 502 protruding from the portion of the edge of the first opening 110 on the +Z side of the edge. When the fluid flows backward through the intake pipe IP in the −Y direction and a part of the fluid flows into the first passage 100 through the second opening 120, the flowmeter 12b can restrict the fluid from biasedly flowing into the first passage 100 around the edge of the second opening 120

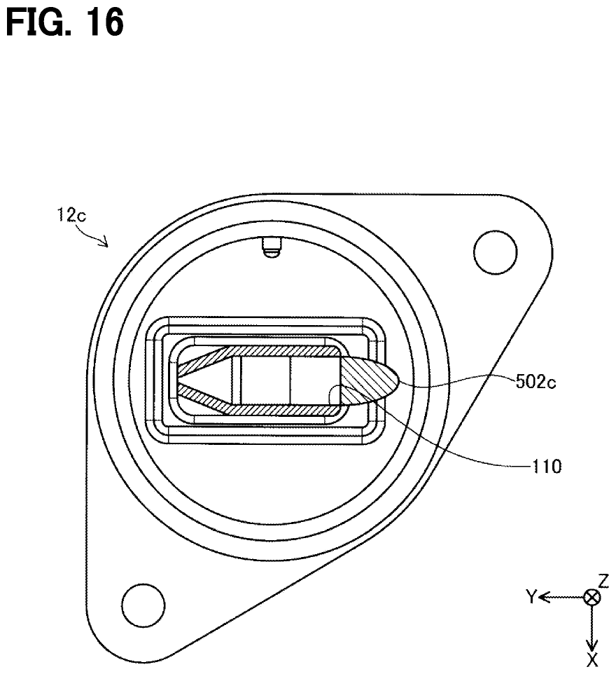

As shown in FIG. 16, a flowmeter 12c of an eleventh embodiment differs from the flowmeter 12 of the second embodiment in FIG. 6 in that the flowmeter 12c includes a protrusion 502c that has a different shape from the protrusion 502 in place of the protrusion 502. Other configurations are similar to those of the flowmeter 12 of the second embodiment. The protrusion 502c has a curved shape viewed from a −Z side of the protrusion 502c. The flowmeter 12c of the eleventh embodiment has similar advantages to those of the second embodiment.

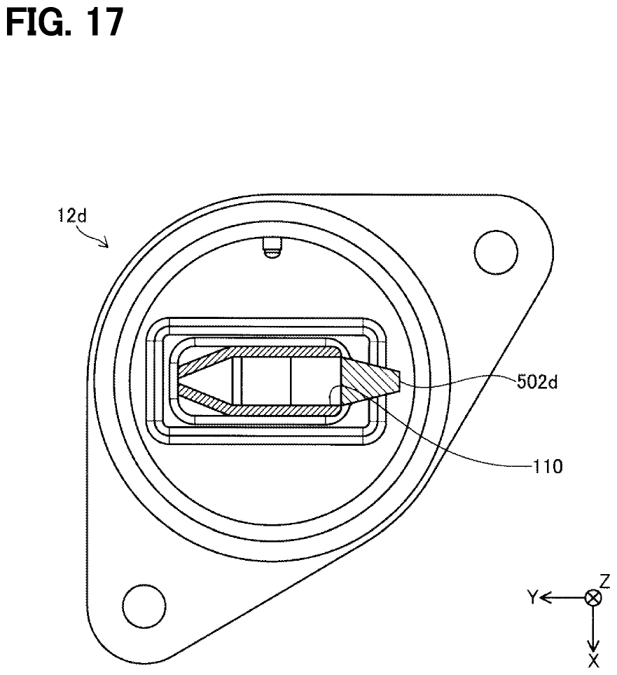

As shown in FIG. 17, a flowmeter 12d of a twelfth embodiment differs from the flowmeter 12 of the second embodiment shown in FIG. 6 in that the flowmeter 12d includes a protrusion 502d that has a different shape from the protrusion 502 in place of the protrusion 502. Other configurations are similar to those of the flowmeter 12 of the second embodiment. The protrusion 502d has a trapezoidal shape viewed from a −Z side of the protrusion 502d. The flowmeter 12d of the twelfth embodiment has similar advantages to those of the second embodiment.

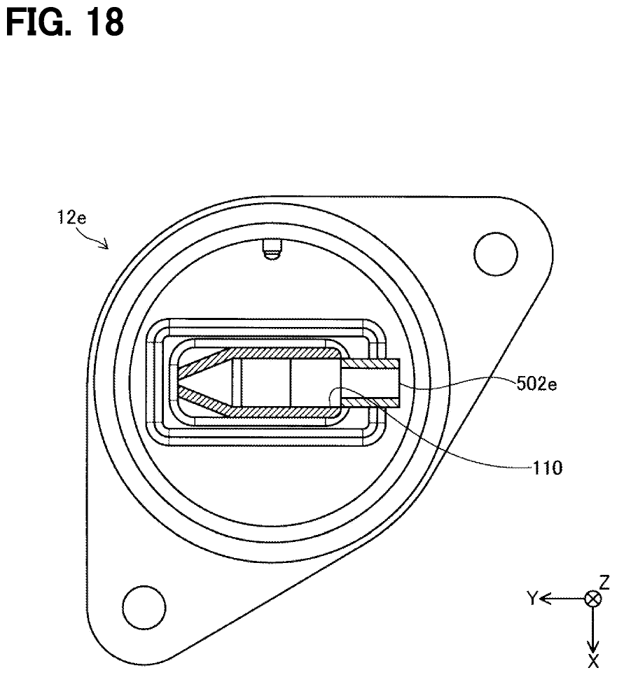

As shown in FIG. 18, a flowmeter 12e of a thirteenth embodiment differs from the flowmeter 12 of the second embodiment shown in FIG. 6 in that the flowmeter 12e includes a protrusion 502e in place of the protrusion 502. Other configurations are similar to those of the flowmeter 12 of the second embodiment. The protrusion 502e has a tubular shape that defines a through hole passing through the protrusion 502e in the Y direction. The protrusion 502e may be formed by extending the first passage 100 in the −Y direction. The flowmeter 12e of the thirteenth embodiment has similar advantages to those of the second embodiment.

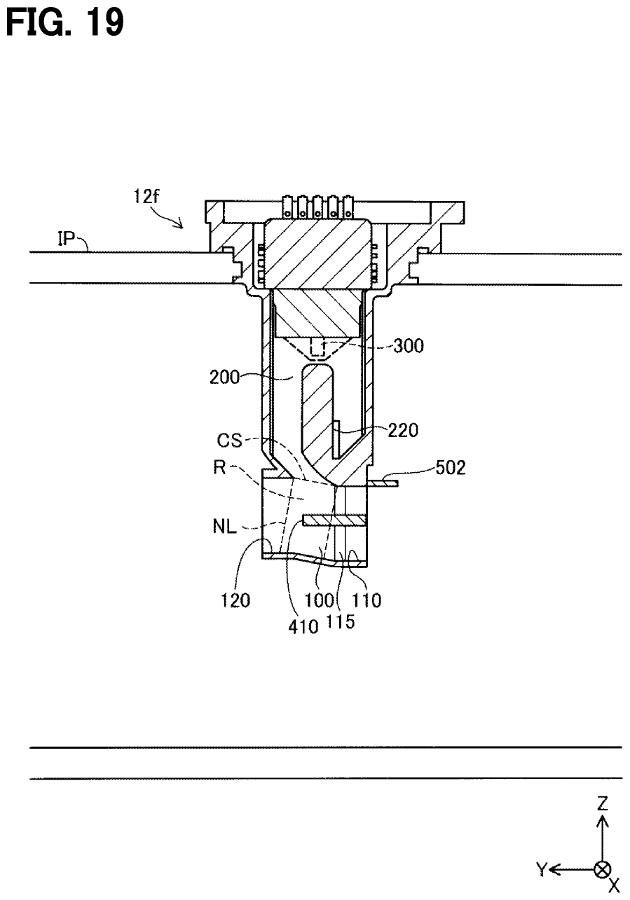

As shown in FIG. 19, a flowmeter 12f of a fourteenth embodiment differs from the flowmeter 12 of the second embodiment in that the flowmeter 12f includes the plate member 410 and defines a fourth opening 115. The plate member 410 has a +Y side end located within the area R. The plate member 410 has a −Y side end located at the −Y side end of the first passage 100. The fourth opening 115 is defined between the first opening 110 and the opening CS at the branching position of the second passage 200. The fourth opening opens in the +X direction. The fourth opening 115 is an opening through which dusts and water accumulated in the first passage 100 flows out. The flowmeter 12f of the fourteenth embodiment has similar advantages to those of the first embodiment.

The present disclosure should not be limited to the embodiments and modifications described above, and various other embodiments may be implemented without departing from the scope of the present disclosure. For example, the technical features in the embodiments can be replaced or combined as appropriate. Also, if the technical features are not described as essential in the present specification, they can be deleted as appropriate.

What is claimed is:

1. A flowmeter disposed in a passage through which a fluid flows, the flowmeter comprising:
a first passage that defines a first opening through which at least a part of the fluid flows into the first passage from the passage; and
a second passage that branches off from the first passage and includes a flow rate detector configured to detect a flow rate of the fluid flowing through the second passage from the first passage, wherein
the first passage includes a vortex reducer configured to restrict a vortex from generating.

2. The flowmeter according to claim 1, wherein
the vortex reducer is a plate member that has at least a part inside the first passage.

3. The flowmeter according to claim 2, wherein
the second passage has an opening that is open to the first passage at a branching position at which the second passage branches off from the first passage, and
the part of the plate member exists within an area defined by virtually projecting the opening along a normal vector of the opening.

4. The flowmeter according to claim 2, wherein
the first passage defines a second opening at a position of the first passage opposite to the first opening,
the first passage includes:
a front passage disposed between the first opening and a branching position at which the second passage branches off from the first passage; and
a rear passage disposed between the front passage and the second opening,
the rear passage is tilted relative to the front passage toward the second passage, and
the plate member is disposed in the front passage.

5. The flowmeter according to claim 2, wherein
a part of the plate member is exposed to an outside of the first opening.

6. The flowmeter according to claim 1, wherein
the first passage defines a second opening at a position of the first passage opposite to the first opening, and
the vortex reducer is a protrusion protruding in a direction away from the first passage from at least one of an opening edge of the first opening and an opening edge of the second opening.
